(19) United States
(12) Patent Application Publication
(10) Pub. No.: US 2003/0160444 A1
(43) Pub. Date: Aug. 28, 2003

(54) Personalized calling card and method for making the card over a computer network

(76) Inventor: Lawrence Durso, Freeport, NY (US)

Correspondence Address: WILLIAM COLLARD, COLLARD & ROE, P.C., 1077 NORTHERN BOULEVARD, ROSLYN, NY, 11576, US

(21) Appl. No.: 10/082,694

(22) Filed: Feb. 22, 2002

(51) Int. Cl. B42D 15/00

(52) U.S. Cl. 283/77

(57) ABSTRACT

The invention relates to a personalized phone card that is designed to display a person's photograph and personal information while also providing the holder of the card with phone card services. The phone card comprises both a front and a back surface wherein on the front surface of the phone card there is a picture of the user along with information about how to use the card along with the telephone number of the person pictured on the front of the card. On the back surface of the card is personal information including a description of the user giving the card. For example, in a preferred embodiment, this description includes biographical information about the person giving the card such as the person's academic record, his or her career information, personal information such as hobbies or interests, a personal quote, or milestones in that person's life such as birthday, his or her wedding anniversary, professional or social accomplishments. In addition, the invention also comprises a process for creating these cards over a computer network. The process includes receiving background information about the user, biographical information such as academic, professional and personal information, and a photograph of the user. This information is then stored in a server and printed out on a phone card.

### BACKGROUND OF THE INVENTION

1. Field of the Invention

The invention relates to a method for creating personal identification phone cards through a computer network. More particularly, the invention relates to a method for making a personal phone card having personal information disposed on that card.

2. The Prior Art Calling cards are known in the art. For example, U.S. Pat. No. 5,921,581 to LaLande discloses a multiple layered card assembly and reproduction thereof. This multiple layered card can be a phone card that contains information in an area that can be hidden and at the same time can provide a large usable area of information that is exposed to the user. The card is varnished and covered with silicone as well.

U.S. Pat. No. 5,774,168 to Blome discloses an identity card, such as a credit card having a picture section, which contains a photo of the card holder. In this section, pixels of different absorptions, especially the gray and black parts are burned by a laser beam cutting into a surface.

U.S. Pat. No. 5,746,451 to Weyer discloses a overlay for the front surfaces of a credit card, ATM or similar transaction card. The overlay is designed so that it allows the cardholder to customize the appearance of a front surface of the cardholder's cards without affecting the operability of the card.

U.S. Pat. No. 3,703,864 to Bradford discloses an imprinting photo-etched credit card while U.S. Pat. No. 3,725,647 to Retzky discloses a photographic credit card system wherein a person's photograph is put on a credit card.

U.S. Pat. No. 6,042,005 to Basile et al. discloses a personal identification and promotional system using personal and medical information. In this case a person can carry an identification card wherein this card contains the user's personal and medical information in an electronic medium. The identification card contains photographs of the user and their parent or legal guardian, a unique identification number for the user and a list of corporate sponsors. The invention also contains a second identification device that is worn by the user and includes a user's unique identification number and an access telephone number.

U.S. Pat. No. 5,695,346 to Sekiguchi et al discloses a process and display with moveable images such as holographic images for a credit card. And finally, U.S. Pat. No. 5,619,025 to Hickman et al discloses a method for tamper-proof identification using photo refractive crystals.

Overall, the present invention differs from the above cited references because while the above cited references have shown credit cards having pictures disposed thereon, the references have not shown a credit card having personal information in a baseball card type display with a person's picture on a front end and his or her biographical information on a back end for use with a phone card. In addition, the prior has also not shown a method for creating a personalized phone card using the internet or other web-based computer program to create a personalized phone card.

### SUMMARY OF THE INVENTION

The invention relates to a personalized phone card that is designed to display a person's photograph and personal information while also providing the holder of the card with phone card services. In this case, the phone card comprises both a front and a back surface wherein disposed on the front surface of the phone card there is a picture of a person on the card hereinafter known as the user along with a quote from the user superimposed over the picture.

On the back surface of the card is a set of biographical information about the user. In a preferred embodiment, this biographical information includes the user's academic record, his or her career information, and personal information such as hobbies or interests, a personal quote, or milestones in that person's life such as his or her birthday, his or her wedding anniversary, professional or social accomplishments etc. In addition, also disposed on the back of the card is a listing of the telephone information including instructions for the recipient of the card on how to use the calling card.

The benefit of this calling card is that this calling card is designed to allow the user to continuously remind the recipient of the user when the user gives the recipient the card.

This calling card is set up so that the user pre-purchases time on the calling card so that the recipient can use the card without having to pay for the call themselves.

In addition, the invention also comprises a process for creating these cards over a computer network. The process includes receiving background information about the user over the computer network, receiving biographical information over the computer network such as academic, professional and personal information, and receiving a photograph of the user. All of this information is transmitted in a digitized format and sent to the server for the computer network. This information is then stored in a server and printed out on a phone card.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings wherein similar reference characters denote similar elements throughout the several views:

FIG. 1 is a front view of the front surface of the card;

FIG. 2 is a front view of the back surface of the card;

FIG. 3 is a front view of the back surface of the second embodiment of the card including the magnetic strip;

FIG. 4 is a block diagram of the computer network for obtaining the information necessary to process the cards according to the invention; and

FIG. 5 is a flow chart detailing the process for creating these cards online.

### DETAILED DESCRIPTION OF THE PREFERRED EMBODIMENT

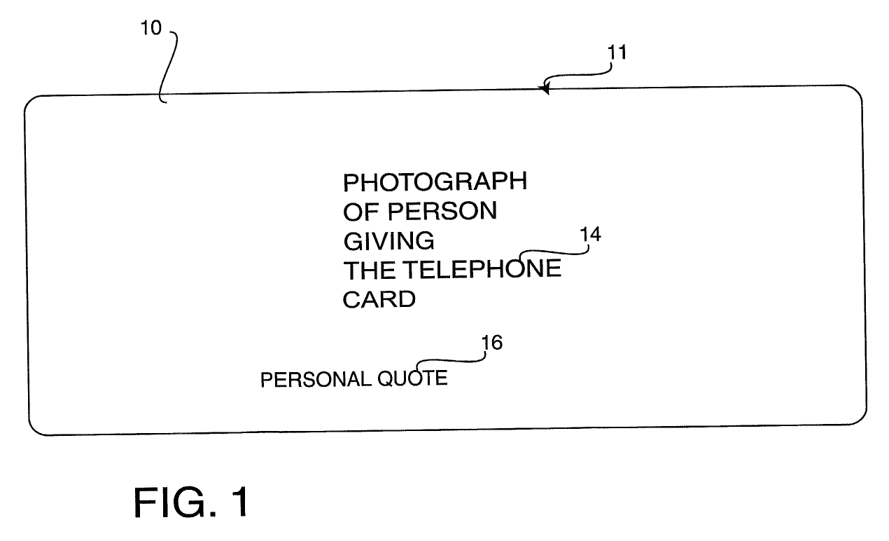

FIG. 1 refers to a front view of a front surface 10 of the card 11 wherein this card 11 is used as a calling card so that a person can order this calling card and deliver customized calling cards to friends associates or relatives as a gift or as a public promotion. The person ordering these cards is known hereinafter as the user wherein the user registers with a central printing office either through an online connection through the Internet or through personal communication through a telephone, mail or fax to register to have these cards made.

The user sends in his or her picture 14 wherein this picture is placed in a region on front face 10 so that whenever the person uses the card, that person sees the user and is reminded of the user. In a preferred embodiment, this picture is displayed across the entire front face 10 of the card. In addition, on front face 10 adjacent to picture 14, is a text region 16 where in a preferred embodiment the user can place his or her personal quote to the recipient. For example, if the user was a mother and the recipient was the user's child then this card was used as a going away gift to the recipient. Thus, the user could state “To my eldest son, call me anytime when you are homesick”.

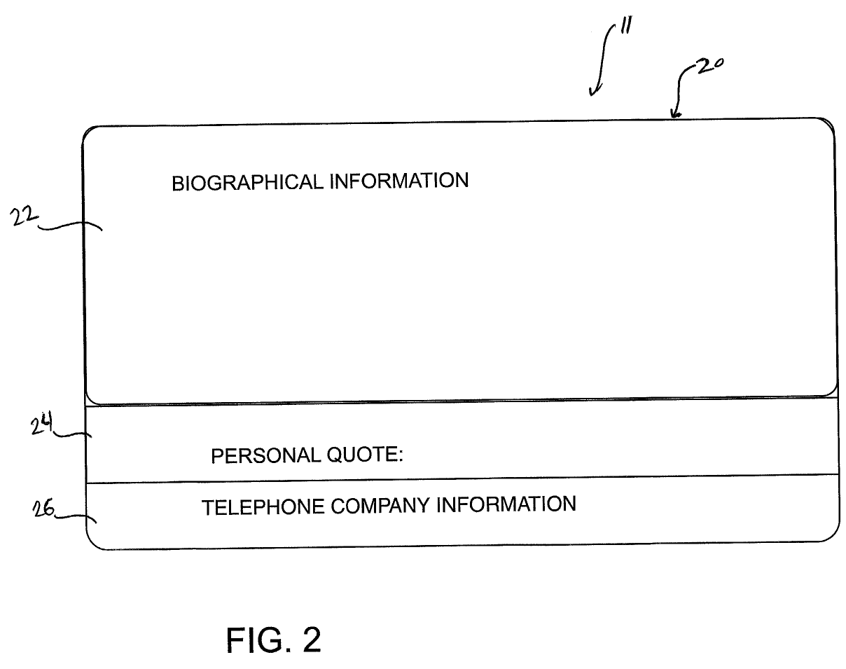

FIG. 2 shows the back face 20 of the calling card 11 wherein this back face includes a text region 22 that includes biographical information about the user, an additional text region 24 containing a personal quote by the user. In a preferred embodiment, the biographical information about the user relates to the user's professional career, the user's educational career, personal interests, and highlights.

The academic history of the user could include the year in which the user graduated from high school, college, and/or graduate school and the highlights of the user's academic career such as any honors that the user received.

The professional history of the user would include information relating to the user's current job status, including the company where the user works, the position that the user holds, and any awards that the user may have received.

The personal history of the user could include the date of birth of the user, the wedding anniversary of the user and the name and birthdate of the user's children. In addition this personal history would also include any personal highlights such as citizenship awards or non-professional honors bestowed upon the user. In addition, disposed on this back face is a text region 26 containing information relating to the calling card company.

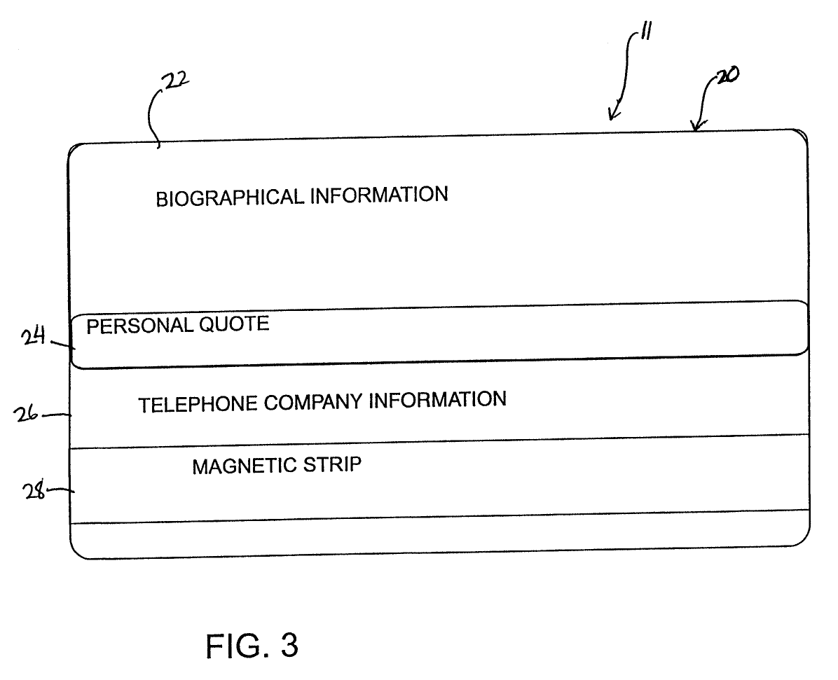

FIG. 3 is a second embodiment of the card 11 wherein in this case, the card contains a magnetic strip 22 on its back face 20. This magnetic strip is designed as a memory store wherein this magnetic strip contains dialing information and security information that is necessary to use the card. In this way, when a person encounters a telephone that will receive and read a card containing a magnetic stripe, then the calling card can be swiped through the telephone to give the recipient access to the calling card.

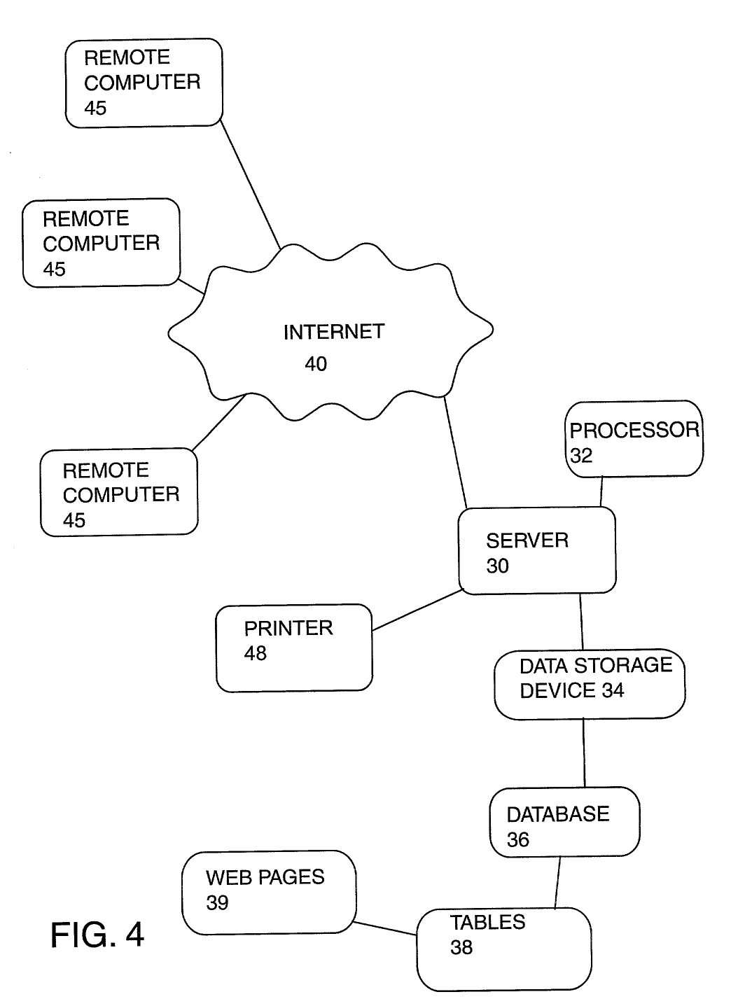

FIG. 4 shows the computer network for processing the information related to this card. The computer network contains a server 30, that is connected to the internet 40. In addition, connected to the internet is a series of remote computers 45 that allow a user to log into server 30 to create cards 11.

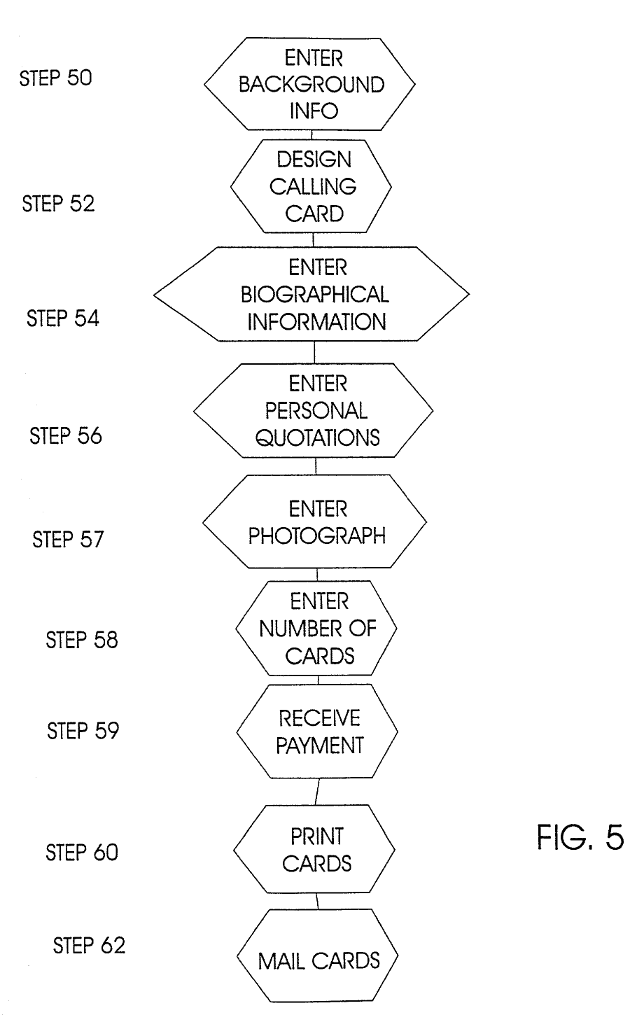

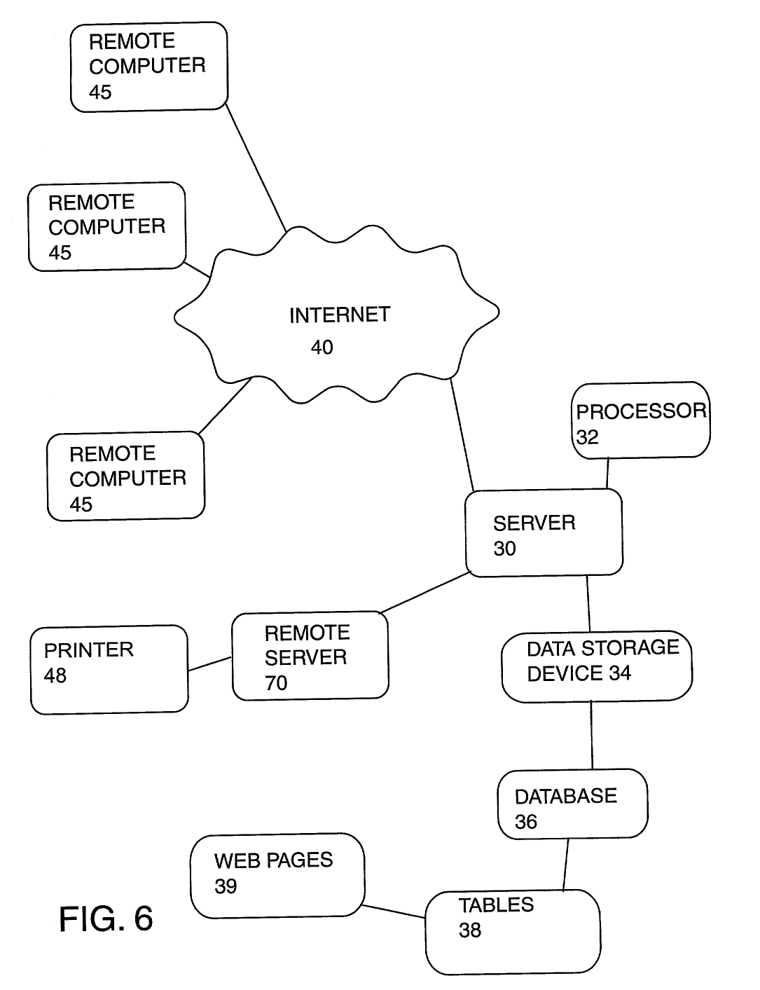

Server 30 contains a processor 32 for processing a computer program for conducting the process shown in FIG. 5. In addition, connected to processor 32 is a data storage device 34 which contains a database 36 for storing information about the users and the cards to be created. Connected to this database 36 is a series of tables that contain particular fields of information. For example, in a preferred embodiment this information includes the academic history of the user, the professional history of the user and the personal highlights in the user's life.

As shown in FIG. 5 the process begins in step 50 when a user logs into a website 39 and enters personal information into the website 39 including name, phone number and email information. Next, in step 52, the user is instructed to design his or her calling card so that this calling card best reflects the user's wishes. For example, the user can select to place the user's picture on a right side of the card or on a left side of the card. In addition, the user can select whether to enter either any or all of the user's academic, professional or personal information on the back of card 11.

Once the card layout has been decided, in step 54, the user next enters his or her academic, professional and personal information into the website so that this information is then stored in database 36 and sorted into table 38. Next, in step 56, the user enters his or her personal quotations to the recipient and philosophical quotations into website 39. This information is then stored in database 36 and sorted into tables 38 so that this information all corresponds to the user. Next, in step 57, the user is asked to enter his or her photograph by uploading a digitized image of the user to website 39. In a preferred embodiment this information can come in the form of a JPEG file wherein the user's image can be taken either from a normal photograph scanned into remote computers 45 or taken from a digital camera. Next, in step 58 the user is asked about the number of cards that the user wants to purchase. For example, a salesman may want to purchase a series of cards that detail the services that his company is selling. In that case the salesman would want to purchase a series of cards for mass distribution. However if the user was a housewife, then the user may only purchase a single card for use by the user's spouse or child.

Once the user selects the number of cards that he or she wants to purchase, in step 59 the user purchases the cards. In a preferred embodiment this purchase step occurs through the use of a credit card transaction online wherein the user enters his or her credit card information into the website 39 wherein this information is stored in database 36 so that server 30 can automatically debit the user's credit card account.

Thus, once all of this information has been entered into database 36 and sorted into tables 38 in step 60, this information can be processed by server 30 so that it creates a card using a printer 48 wherein this printer prints a number of cards relating to the number entered by the user in step 58. In a preferred embodiment, the printing of the card would occur on a remote site using a remote server 70 as shown in FIG. 6. This remote server is connected through the computer network to server 30 at one end and also connected to printer 48 for printing the cards. This printer 48 is preferably made by Eltron wherein as model P420. This printer is designed to receive digital information in the form of pictures, and text. This information is then printed on cards made from either PVC or a composite. Next, in step 62 these cards are then mailed to the user so that the user can present these cards as a gift to a recipient of the user's choice.

Accordingly, while several embodiments of the present invention have been shown and described, it is to be understood that many changes and modifications may be made thereunto without departing from the spirit and scope of the invention as defined in the appended claims.

What is claimed is:

1. A calling card comprising:
a) a card;
b) a personal photo disposed on said card;
c) a personal information list disposed on said card wherein said personal information list pertains to a user shown in said personal photo on said card backing; and
d) a set of phone company information disposed on said card wherein said phone company information contains a series of instructions to guide a recipient on how to use the calling card.

2. The calling card as in claim 1, wherein said personal information list contains biographical information about said user in said personal photo.

3. The calling card as in claim 1, wherein said personal information list is disposed on a side of said card backing opposite said photo.

4. The calling card as in claim 1, further comprising memory store disposed on said card wherein said memory store is in the form of a magnetic strip.

5. The calling card as in claim 1, wherein said personal information list contains information about said users educational history.

6. The calling card as in claim 1, wherein
said personal information list contains information about said user's professional history.

7. The calling card as in claim 1, wherein
said personal information list contains information about said user's personal highlights such as the user's birthday, wedding anniversary, or the date of birth of the user's children and the name of the user's children.

8. The calling card as in claim 1, wherein said personal information list contains said user's telephone number.

9. A process for creating a personalized phone card over a computer network comprising:
a) receiving background information from a user over the computer network and storing this information in a server;
b) presenting a web page to said user for designing the personalized phone card over the computer network;
c) receiving biographical information relating to the user and storing this information in the server;
d) receiving a photograph from said user; and
e) printing a series of cards containing said user's biographical information and said user's photograph on a printer attached to said server.

10. The process as in claim 8 wherein said step of receiving biographical information includes receiving information relating to said users academic, professional and personal life.

11. The process as in claim 8, further comprising the step of presenting a question to the user regarding the number of cards that the user would like printed.

12. The process as in claim 8, further comprising the step of presenting a question to said user regarding the particular phone company that the user would like to associate the card with.

13. The process as in claim 8, further comprising the step of storing said biographical information into a database and sorting said biographical information in a table.
